(19) United States
(12) Patent Application Publication
(10) Pub. No.: US 2014/0067583 A1
(43) Pub. Date: Mar. 6, 2014

(54) ACTION CONFIRMATION MECHANISM

(71) Applicant: Bruce Yarnall, Portland, OR (US)

(72) Inventor: Bruce Yarnall, Portland, OR (US)

(73) Assignee: eBay Inc., San Jose, CA (US)

(21) Appl. No.: 13/605,289

(22) Filed: Sep. 6, 2012

(51) Int. Cl. G06Q 30/08

(52) U.S. Cl. 705/26.3

(57) ABSTRACT

Disclosed in some examples is a method for verification of a user action comprising: presenting, on a display, a user input control to take an action; receiving a user input directed to the user input control; presenting a second user input control responsive to the received user input directed to the user input control wherein the second user input control is only presented while the input directed to the user input control is still present; and determining that the user intends to take the action based upon receiving a second user input directed to the second user input control.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, All Rights Reserved.

### BACKGROUND

Retailers are often looking for ways to make purchasing easier for electronic commerce sites. For example, Amazon.com features a single click purchasing interface where users click a single button to purchase the item using a predetermined payment method. Items purchased are then shipped to a predetermined address.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a flow diagram of an example action confirmation method according to some examples of the present disclosure.

FIG. 2 shows a flow diagram of an example action confirmation method according to some examples of the present disclosure.

FIG. 3 shows a flow diagram of an example action confirmation method according to some examples of the present disclosure.

FIG. 4 shows a flow diagram of an example action confirmation method according to some examples of the present disclosure.

FIG. 5 shows a schematic of an example network commerce system according to some examples of the present disclosure.

FIG. 6 shows a schematic of an example mobile device according to some examples of the present disclosure.

FIG. 7 shows a schematic of an example client application according to some examples of the present disclosure.

FIG. 8 shows a schematic of a machine according to some examples of the present disclosure.

### DETAILED DESCRIPTION

As payment and ordering have gotten easier, the risk increases that consumers may inadvertently purchase an item. While electronic commerce sites may allow for order cancellations, these cancellations may impose additional costs for retailers. For example, an item may need to be restocked, shipped back by the customer, or exchanged—all of which imposes costs on the retailer.

These easy purchasing techniques (e.g., single click or single action mechanisms) pose even more difficult problems for online marketplaces featuring auction mechanisms. For example, it becomes problematic to undo all the events happening after an erroneous bid as, bidders often set the system to automatically increment their bids to a predetermined maximum. Thus an erroneous bid may automatically trigger additional bidding. In some cases, an unintended bid can reveal another bidder's maximum bid price, potentially giving other bidders an unfair advantage if the auction is re-run. If the erroneous bid wins the auction, the consequences of the retraction can include relisting the item, contacting the next highest bidder, and the like. The bidder may also suffer consequences of their unintended bid through the form of negative feedback and online reputation.

These problems are only exacerbated by the prevalence of mobile devices. Buttons on mobile devices are often closely spaced together and it is easy for users to inadvertently push the wrong button. Additionally, touch screens suffer from problems where the device registers a touch in a spot the user did not intend, or registers a phantom touch—such as someone's keys pressing against the device in their pockets.

Disclosed in some examples are methods, systems, and machine readable media for verifying a user's action and thus preventing unintended actions. The system may present a first user input control, such as a button, which must be activated to take the action. Upon continued activation of the first user input control (such as by holding the button) the system may enable a confirmation mode. For example, a second user input control may be displayed (such as a second button, or a second area on the first button), which must be activated, along with the continued activation of the first user input control in order to execute the action. Once both user input controls receive the appropriate input, the particular action may be considered confirmed, and in some examples be executed. This serves to prevent unintended actions such as unintended item bids, unintended purchases, unintended acceptance of legal terms (e.g., terms of use policies), unintended changes in an application or system settings, or the like.

In other examples, this verification process may allow for the presentation of additional information about the particular action to the user during the confirmation mode. For example, in an online marketplace setting, the default payment method that will be used may be displayed, the default shipping address that will be used may be displayed, or the like. This may provide further confirmation that the action and the details associated with the transaction are correct.

A user input control may be any logical component that receives input from the user of a computing device. The user input control may receive input from one or more input devices (e.g., physical buttons, touch screens, mice, accelerometers, gesture commands, voice commands, or the like), and in some examples the user input control may be associated with graphical elements such as buttons (e.g., buttons on a touch screen), lists, drop-down menus, radio buttons, or the like. A user input control is enabled when the computing device displays the user input control (if applicable, e.g., in the case of a touch-screen display) and is configured to process input from the user input control in association with confirming the action. A user input control is activated when user input is registered by the computing device and associated with the user input control—for example, when a button is depressed.

The second user input control may be an extension of the first user input control. For example, if the first user input control is a touch screen button, once the button is pressed and held (in some examples for a particular period of time which may be predetermined) the button may expand such that a second button is shown next to, near, or inside of the first button. Pressing the second button (while the first button is still held) may confirm the action, and in some examples, cause the action to be executed. In other examples, the second user input control may be a separate control that is either the same type or a different type of input control than the first input control. The second user input control may utilize the same input device but two different graphical representations (e.g., two different graphical touchscreen buttons). For example, if the first user input control is a physical button, the second user input control may be a second physical button which when depressed causes the action to be performed. In some examples, devices which do not support multi-touch touch screen displays may utilize a first user input control which is a touch screen button and a second user input control which may be a physical button (for example a volume key), or vice-versa (e.g., the first user input control is a physical button and the second user input control is the touch screen button).

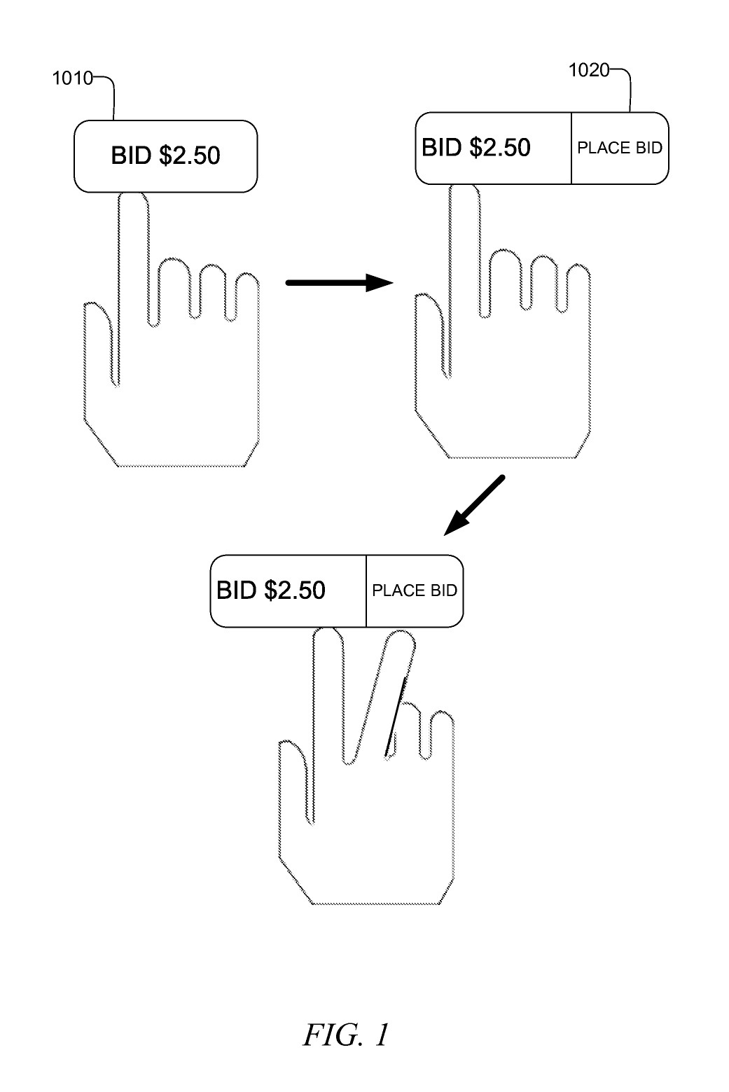

Turning now to FIG. 1, an example bid confirmation method and system operating on a touchscreen device is shown. At 1010, a first user input control in the form of a button is displayed. Upon pressing and holding the button 1010 for a predetermined period, a second user input control 1020, in the form of a second button, appears next to (and appears integrated with) button 1010. By continuing to hold button 1010 and pressing button 1020, the user is able to bid on the item.

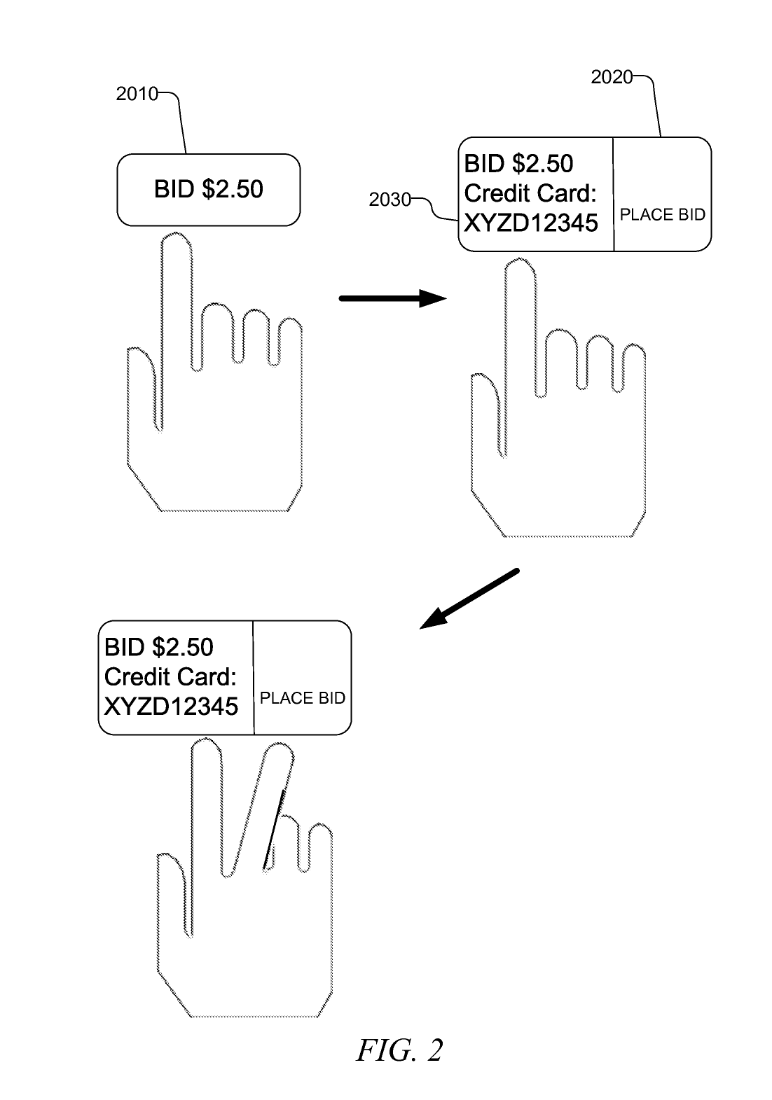

Turning now to FIG. 2, another example bid confirmation method and system operating on a touchscreen device is shown. Similar to FIG. 1 the first button 2010 must be pressed and held to activate the second user input control 2020, which must then be pressed simultaneously to perform the action. In the example of FIG. 2, once the button is held for the predetermined amount of time, additional information regarding the transaction is displayed at 2030. This information may display any information related to the transaction and may be displayed integrated with the first input control, the second input control, or somewhere else on screen. Information related to the transaction may include one or more of the bid or item amount or price, item description, item quantity, shipping information (e.g., shipping cost, shipping address, shipping carrier or options, or the like), payment information (e.g., payment form, payment accounts, or the like), or the like. In other examples, the information displayed at 2030 may be legal information such as terms-of-use or the like.

In some examples, once the user activates the second input control, the action may be performed. In examples in which the action to be confirmed is to bid on, or purchase an item, the network commerce system may allow users to pre-specify payment information, shipping information, or any other transactional information to use with this system, such that when the user bids on the item or selects the item for purchase, the item is bid upon, or purchased using the payment, shipping, and other transactional information pre-specified by the user.

In yet other examples, the second input control may allow for changing the transactional information. For example, the second input control may be a series of one or more buttons, each button corresponding to a particular payment, shipping or other transactional option which may be stored in the user's account.

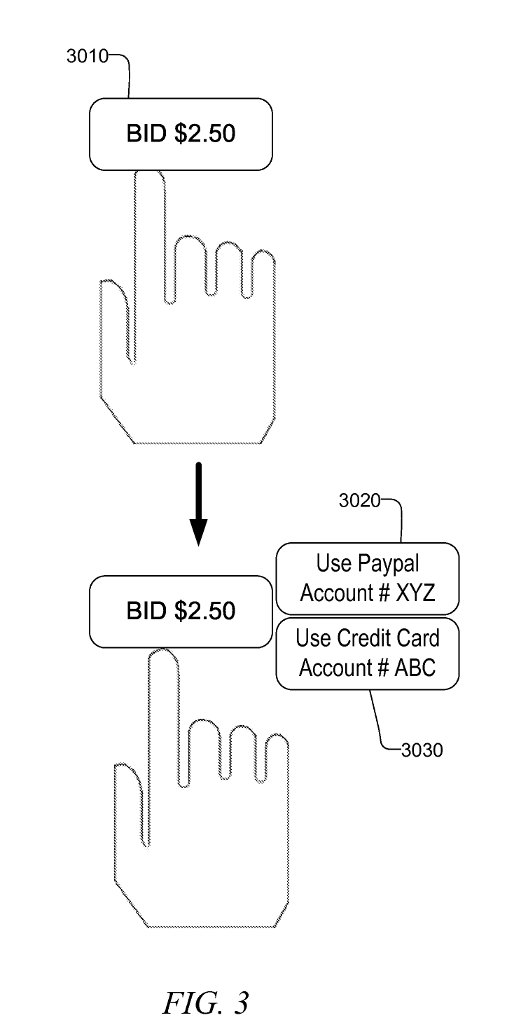

Turning now to FIG. 3, an example second input control which allows for selecting different payment options is shown. Upon depressing the first input control 3010 for a predetermined period of time, the system may display a second user input control comprising the two buttons 3020 and 3030 which may display the payment options associated with the user's account. To complete the bid, the user must push one of the buttons of the second input control to select the account to use (along with holding the first button 3010). While payment options were shown in FIG. 3, other options may be presented instead of, or in addition to the payment options, such as shipping options. While additional buttons were shown in FIG. 3, in other examples the second input control may be different user input controls, such as a drop down box with all the payment options which are associated with the user's account.

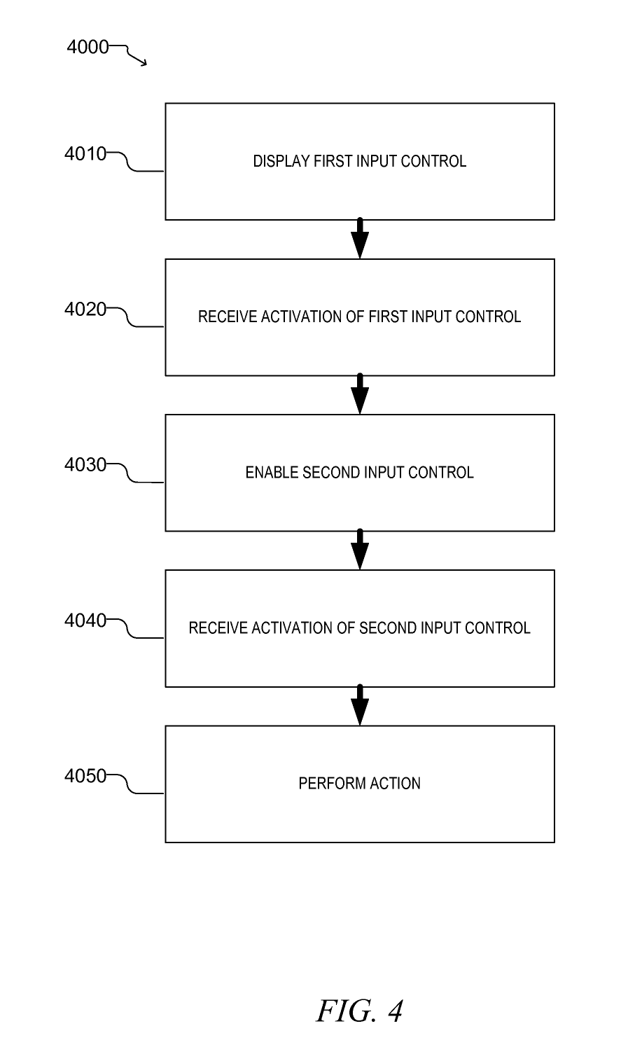

Turning now to FIG. 4, an example action confirmation method 4000 is shown. At operation 4010 the first input control may be displayed by the system (for example, if the control is a button on a touch screen interface). At operation 4020, the first input control is activated. In some examples, activation of the first input control 4020 may include a touch event corresponding to the on-screen location of a button, a gesture associated with the first input control 4020, a movement sensed by an accelerometer (or some other positional device), an event indicating the depression of a physical button, or the like. Once the first input control 4020 is in an active state for a predetermined amount of time, a second input control 4030 may be enabled (e.g., an input control may be displayed on the display of a touch screen). Once it is determined that the second input control is activated (in some examples, the first input control must remain active during the activation of the second input control) at operation 4040, the action may be performed.

While the above examples described a method in which the user had to activate the first input control for a predetermined time period and continue to keep the first input control active (e.g., hold the button) while activating the second user input control, in other examples, other activation sequences may be used. For example, simply activating the first input control may cause the second user input control to be enabled. Thus the second user input control may be caused to be enabled immediately after the system receives an event indicating activation of the first user input control.

While examples previously described confirm the action upon activation of the second user input control while continuing the activation of the first user input control, in other examples, once the second user input control is enabled, the user may not have to continue to keep the first input control active (e.g., hold it). Thus the user may press the first user input control (in some examples, hold it for a predetermined period of time) and once the second input control is active, may remove their finger from the first user input control and then activate the second user input control. In these examples, the second user input control may remain enabled until the user takes another action, or a second predetermined time period has elapsed and the user has not activated the second user input control, or both. For example, the second user input control may be hidden after 10 seconds, or the like. This second predetermined time period provides a safety mechanism to prevent accidental actions.

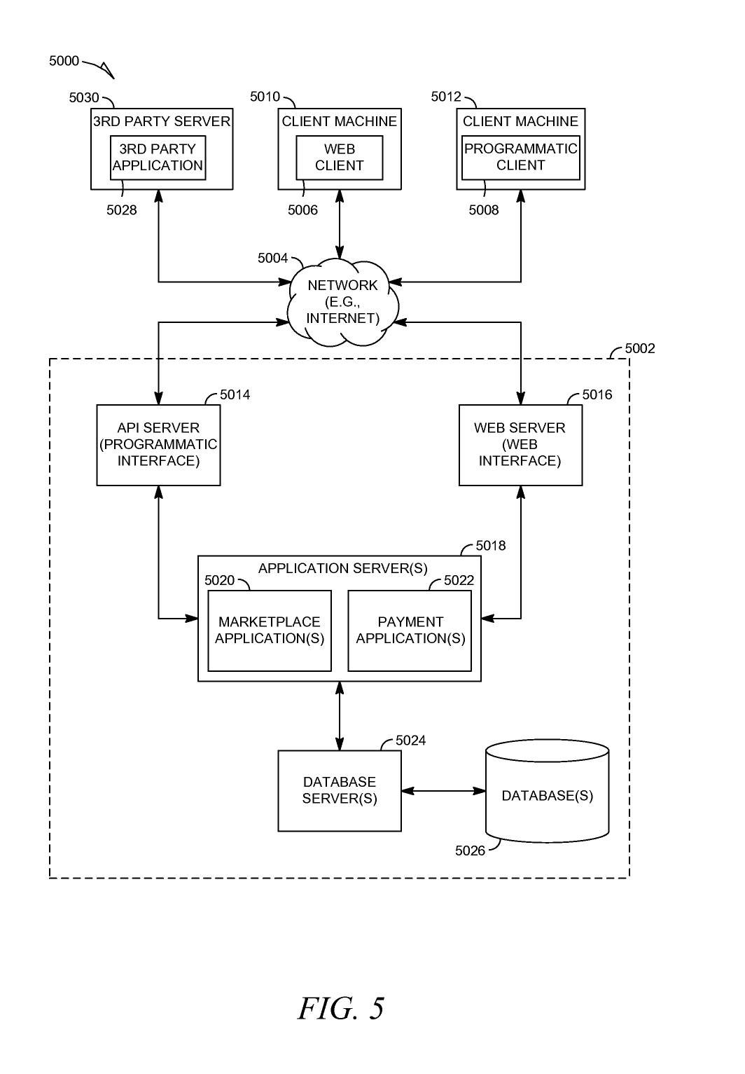

FIG. 5 is a network diagram depicting a client-server system 5000, within which one example embodiment may be deployed. A networked system 5002, in the example forms of a network-based marketplace or publication system, provides server-side functionality, via a network 5004 (e.g., the Internet or Wide Area Network (WAN)) to one or more clients. FIG. 5 illustrates, for example, a web client 5006 (e.g., a browser, such as the Internet Explorer browser developed by Microsoft Corporation of Redmond, Wash. State), and a programmatic client 5008 executing on respective client machines 5010 and 5012.

An Application Program Interface (API) server 5014 and a web server 5016 are coupled to, and provide programmatic and web interfaces respectively to, one or more application servers 5018. The application servers 5018 host one or more marketplace applications 5020 and payment applications 5022. The application servers 5018 are, in turn, shown to be coupled to one or more databases servers 5024 that facilitate access to one or more databases 5026.

The marketplace applications 5020 may provide a number of marketplace functions and services to users that access the networked system 5002. The payment applications 5022 may likewise provide a number of payment services and functions to users. The payment applications 5022 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 5020. While the marketplace and payment applications 5020 and 5022 are shown in FIG. 5 to both form part of the networked system 5002, it will be appreciated that, in alternative embodiments, the payment applications 5022 may form part of a payment service that is separate and distinct from the networked system 5002. One or more of marketplace and payment applications 5020 and 5022, web client 5006, programmatic client 5008, or other components may store user account information about users of those components. Example information may include payment information, shipping information, user preferences, or the like. Additionally, one or more of marketplace and payment applications 5020 and 5022, web client 5006, programmatic client 5008, or other components may include the action confirmation mechanisms disclosed herein.

Further, while the system 5000 shown in FIG. 5 employs a client-server architecture, the present invention is of course not limited to such an architecture, and could equally well find application in a distributed, or peer-to-peer, architecture system, for example. The various marketplace and payment applications 5020 and 5022 could also be implemented as standalone software programs, which do not necessarily have networking capabilities.

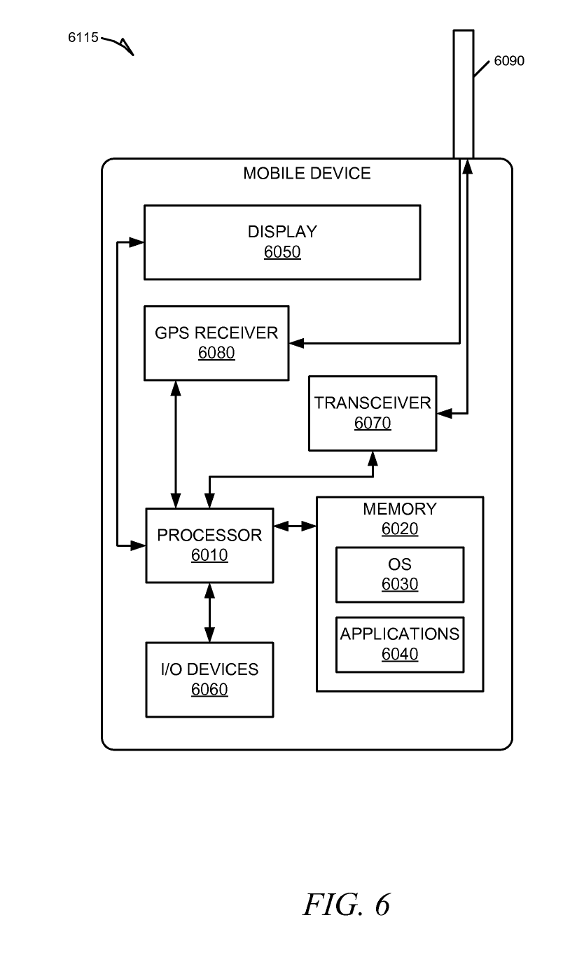

The web client 5006 accesses the various marketplace and payment applications 5020 and 5022 via the web interface supported by the web server 5016. Similarly, the programmatic client 5008 accesses the various services and functions provided by the marketplace and payment applications 5020 and 5022 via the programmatic interface provided by the API server 5014. The programmatic client 5008 may, for example, be a seller application (e.g., the TurboLister application developed by eBay Inc., of San Jose, Calif.) to enable sellers to author and manage listings on the networked system 5002 in an off-line manner, and to perform batch-mode communications between the programmatic client 5008 and the networked system 5002. In other examples, the programmatic client may include a mobile application executing on a mobile device (such as the mobile device described with respect to FIG. 6) which may allow the user of the mobile application to bid on, purchase, view, and/or list items for sale on the online marketplace. The programmatic client 5008 may include the action confirmation features discussed herein. The confirmation features discussed herein may also be part of the web based interface provided by web server 5016 and displayed by web client 5006 of the client machine 5010.

FIG. 5 also illustrates a third party application 5028, executing on a third party server machine 5030, as having programmatic access to the networked system 5002 via the programmatic interface provided by the API server 5014. For example, the third party application 5028 may, utilizing information retrieved from the networked system 5002, support one or more features or functions on a website hosted by the third party. The third party website may, for example, provide one or more promotional, marketplace or payment functions that are supported by the relevant applications of the networked system 5002.

FIG. 6 is a block diagram illustrating a mobile device 6115, according to an example embodiment upon which various embodiments may execute. The mobile device 6115 may include a processor 6010. The processor 6010 may be any of a variety of different types of commercially available processors suitable for mobile devices (for example, an XScale architecture microprocessor, a Microprocessor without Interlocked Pipeline Stages (MIPS) architecture processor, a processor operating according to a Reduced Instruction Set (RISC) such as a PowerPC processor, a processor operating according to a Complex Instruction Set (CISC) such as an Intel x086 processor, or another type of processor). A memory 6020, such as a Random Access Memory (RAM), a Flash memory, or other type of memory, may be communicatively coupled to the processor (e.g., through a bus or other communication pipeline). The memory 6020 may be adapted to store an operating system (OS) 6030, as well as application programs 6040, such as an application which allows users to create final product images according to the present disclosure. Example OS' include the Android OS developed by Google Inc., of Mountain View Calif., iOS developed by Apple of Cupertino, Calif., Windows Mobile developed by Microsoft Corp., of Redmond Wash., or the like. The processor 6010 may be coupled, either directly or via appropriate intermediary hardware, to a display 6050 and to one or more input/output (I/O) devices 6060, such as a keypad, a touch panel sensor, a microphone, and the like. For example, the mobile device 6115 may include multi-touch-screen displays which support input entry through multi-touch gestures. Example multi-touch screen displays include capacitive touch screen displays, resistive touch screen displays, or the like. Similarly, in some embodiments, the processor 6010 may be coupled to a transceiver 6070 that interfaces with an antenna 6090. The transceiver 6070 may be configured to both transmit and receive cellular network signals, wireless data signals, or other types of signals via the antenna 6090, depending on the nature of the mobile device 6115. In this manner, a connection with a communication network may be established. For example, the transceiver may operate in accordance with a 2^{nd} Generation wireless network (e.g., a Global System for Mobile Communications GSM network, a General Packet Radio Service GPRS network), a 3^{rd} Generation wireless network (e.g., a Universal Mobile Telecommunications Network UMTS), a 4^{th} Generation wireless network (e.g., Long Term Evolution LTE, Long Term Evolution-Advanced LTE-A), a network according to an Institute for Electrical and Electronics Engineers IEEE 802.11 family of standards (such as 802.11n) or the like. Further, in some configurations, a Global Positioning System receiver 6080 may also make use of the antenna 6090 to receive GPS signals. Mobile device 6115 may access networked system 5002 of FIG. 5 through the execution of a programmatic client 5008 or a web client 5006, or some other client.

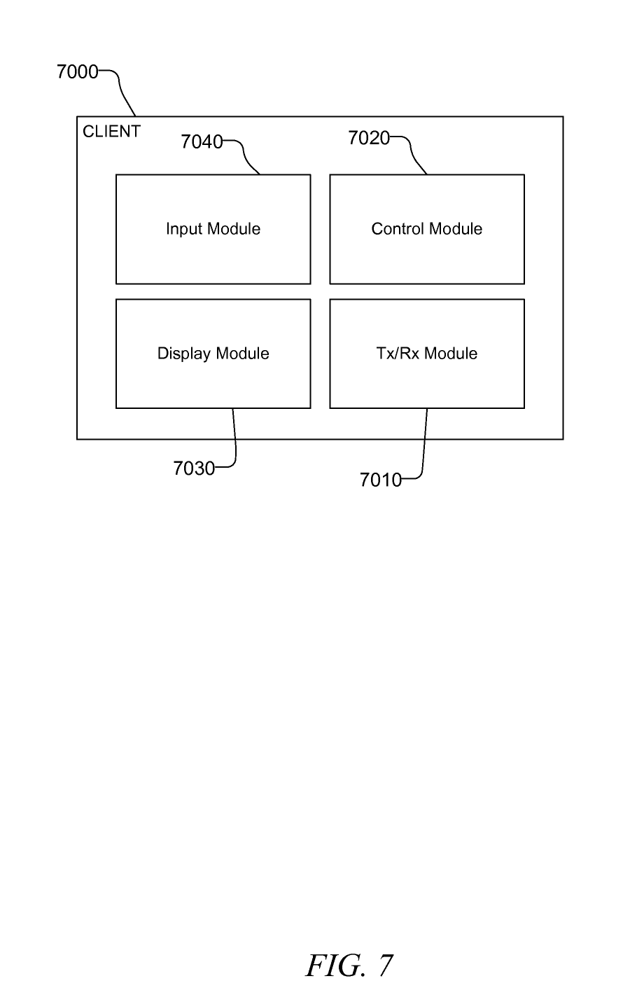

FIG. 7 shows an example programmatic client 5008 or of web client 5006 in the form of client 7000. Tx/Rx module 7010 may receive and transmit information over the network 5004. Example information received includes information regarding the network marketplace 5002 and may include product information, transaction information (payment and shipping information), and the like. Example information transmitted includes user information (user id/password), user selections and inputs (e.g., payment information, shipping information inputted by the user), user bids and purchase requests, or the like. The information transmitted or received may be in any form (e.g., HyperTextMarkup Language pages, special protocols, or the like).

Control module 7020 may process information received by the Tx/Rx module 7010 and cause information to be transmitted to the network-based marketplace through the Tx/Rx module 7010. Control module 7020 may display information received by the Tx/Rx module 7010 on the display of the device (e.g., a mobile device, a desktop computer, laptop computer, or the like) through display module 7030.

Control module may also be responsible for instructing the display module 7030 to display the first user input control and the second user input control at the appropriate times and under the appropriate circumstances as previously described, and/or enabling the first and second user input controls.

Input module 7040 may sense one or more inputs (including inputs to the first and second user input controls) and notify the control module. The control module may take appropriate action upon receipt of this notification. For example, upon receiving a notification that the first user input control has been activated for a particular period of time, the control module 7020 may instruct the display module 7030 to display and/or enable the second user input control. Upon receipt of a notification that the second user input control has been activated the control module 7020 may take the appropriate action (e.g., submitting a bid, purchasing a product, etc. . . . ). For example, the control module 7020 may submit a bid or purchase by instructing the TX/RX module 7010 to submit a bid to the network system 5002.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or in a “software as a service” (SaaS) type architecture. For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

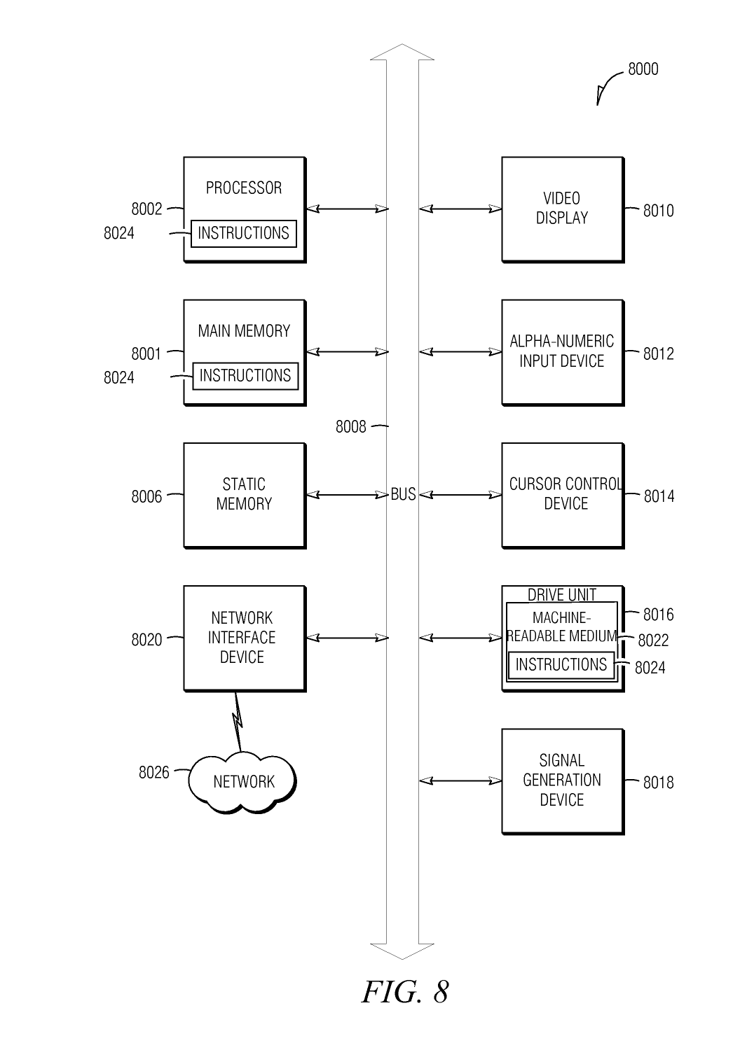

FIG. 8 is a block diagram of machine in the example form of a computer system 8000 within which instructions, for causing the machine to perform any one or more of the methodologies discussed herein, may be executed. Any of the components of FIGS. 5-7 may be or include one or more components shown in FIG. 8. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 8000 includes a processor 8002 (e.g., a central processing unit (CPU), a graphics processing unit (GPU) or both), a main memory 8004 and a static memory 8006, which communicate with each other via a bus 8008. The computer system 8000 may further include a video display unit 8010 (e.g., a liquid crystal display (LCD) or a cathode ray tube (CRT)). The computer system 8000 also includes an alphanumeric input device 8012 (e.g., a keyboard), a user interface (UI) navigation device 8014 (e.g., a mouse), a disk drive unit 8016, a signal generation device 8018 (e.g., a speaker) and a network interface device 8020.

### Machine-Readable Medium

The disk drive unit 8016 includes a machine-readable medium 8022 on which is stored one or more sets of instructions and data structures (e.g., software) 8024 embodying or used by any one or more of the methodologies or functions described herein. The instructions 8024 may also reside, completely or at least partially, within the main memory 8004, static memory 8006, and/or within the processor 8002 during execution thereof by the computer system 8000, the main memory 8004 and the processor 8002 also constituting machine-readable media.

While the machine-readable medium 8022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

### Transmission Medium

The instructions 8024 may further be transmitted or received over a communications network 8026 using a transmission medium. The instructions 8024 may be transmitted using the network interface device 8020 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

### Other Notes

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### OTHER EXAMPLES

### Example 1

A method for verification of a user action comprising: presenting, on a display, a user input control to take an action; receiving a user input directed to the user input control; presenting a second user input control responsive to the received user input directed to the user input control, wherein the second user input control is only presented while the input directed to the user input control is still present; and determining that the user intends to take the action based upon receiving a second user input directed to the second user input control.

### Example 2

The method of example 1, wherein the user input control is a button.

### Example 3

The method of any one of examples 1-2, wherein the action is one of: bidding on an item in an online marketplace or purchasing an item in an online marketplace.

### Example 4

The method of any one of examples 1-3, wherein presenting the second user input control includes presenting transactional information for the bid or the purchase.

### Example 5

The method of example 4, wherein the transactional information includes information on payment methods.

### Example 6

The method of any one of examples 4-5, wherein the transactional information includes shipping information.

### Example 7

The method of any one of examples 1-6, further comprising: completing the bid process or the purchase process automatically responsive to determining that the user intends to take the action based upon receiving the second user input control.

### Example 8

The method of any one of examples 1-7, wherein the second user input control is an extension of the first user input control.

### Example 9

The method of any one of examples 1-8, wherein the user input directed to the user input control is a touch input to a location on a touch screen display.

### Example 10

The method of example 9, wherein the second user input control is presented after the user input directed to the user input control is held for a predetermined period of time.

### Example 11

The method of example 10, wherein the user input directed to the second user input control is a touch input to a second location on a touch screen display.

### Example 12

The method of any one of examples 1-7, wherein the user input directed to the user input control is a button press input of a physical button.

### Example 13

A system for verification of a user action comprising: a display module configured to present on a display, a user input control to take an action; an input module configured to receive a user input directed to the user input control; wherein the display module is further configured to present a second user input control responsive to the received user input directed to the user input control, wherein the second user input control is only presented while the input directed to the user input control is still present, and wherein the input module is further configured to receive a second user input directed to the second user input control; and a control module configured to determine that the user intends to take the action based upon receiving the second user input directed to the second user input control.

### Example 14

The system of example 13, wherein the user input control is a button.

### Example 15

The system of any one of examples 13-14, wherein the action is one of: bidding on an item in an online marketplace or purchasing an item in an online marketplace.

### Example 16

The system of any one of examples 13-15, wherein the display module is configured to present transactional information for the bid or the purchase with the second user input control.

### Example 17

The system of example 16, wherein the transactional information includes information on payment methods.

### Example 18

The system of any one of examples 16-17, wherein the transactional information includes shipping information.

### Example 19

The system of any one of examples 13-18, wherein the control module is configured to complete the bid process or the purchase process automatically responsive to determining that the user intends to take the action based upon receiving the second user input control.

### Example 20

The system of any one of examples 13-19, wherein the second user input control is an extension of the first user input control.

### Example 21

The system of any one of examples 13-20, wherein the user input directed to the user input control is a touch input to a location on a touch screen display.

### Example 22

The system of example 21, wherein the display module is configured to present the second user input control after the user input directed to the user input control is held for a predetermined period of time.

### Example 23

The system of example 22, wherein the user input directed to the second user input control is a touch input to a second location on a touch screen display.

### Example 24

The system of any one of examples 13-20, wherein the user input directed to the user input control is a button press input of a physical button.

### Example 25

A machine readable medium that stores instructions which when performed by a machine, cause the machine to perform operations comprising: presenting, on a display, a user input control to take an action; receiving a user input directed to the user input control; presenting a second user input control responsive to the received user input directed to the user input control, wherein the second user input control is only presented while the input directed to the user input control is still present; and determining that the user intends to take the action based upon receiving a second user input directed to the second user input control.

### Example 26

The machine readable medium of example 25, wherein the user input control is a button.

### Example 27

The machine readable medium of any one of examples 25-26, wherein the action is one of: bidding on an item in an online marketplace or purchasing an item in an online marketplace.

### Example 28

The machine readable medium of any one of examples 25-27, wherein the instructions for presenting the second user input control includes instructions, which when performed by the machine cause the machine to at least present transactional information for the bid or the purchase.

### Example 29

The machine readable medium of example 28, wherein the transactional information includes information on payment methods.

### Example 30

The machine readable medium of any one of examples 28-29, wherein the transactional information includes shipping information.

### Example 31

The machine readable medium of any one of examples 25-30, wherein the instructions include instructions which when executed cause the machine to perform the operations of completing the bid process or the purchase process automatically responsive to determining that the user intends to take the action based upon receiving the second user input control.

### Example 32

The machine readable medium of any one of examples 25-31, wherein the second user input control is an extension of the first user input control.

### Example 33

The machine readable medium of any one of examples 25-32, wherein the user input directed to the user input control is a touch input to a location on a touch screen display.

### Example 34

The machine readable medium of example 33, wherein the instructions cause the machine to present the second user input control after the user input directed to the user input control is held for a predetermined period of time.

### Example 35

The machine readable medium of example 34, wherein the user input directed to the second user input control is a touch input to a second location on a touch screen display.

### Example 36

The machine readable medium of example 25-32, wherein the user input directed to the user input control is a button press input of a physical button.

What is claimed is:

1. A method for verification of a user action comprising:
presenting, on a display, a user input control to take an action;
receiving a user input directed to the user input control;
presenting a second user input control responsive to the received user input directed to the user input control, wherein the second user input control is only presented while the input directed to the user input control is still present; and
determining that the user intends to take the action based upon receiving a second user input directed to the second user input control.

2. The method of claim 1, wherein the user input control is a button.

3. The method of claim 1, wherein the action is one of: bidding on an item in an online marketplace or purchasing an item in an online marketplace.

4. The method of claim 3, wherein presenting the second user input control includes presenting transactional information for the bid or the purchase.

5. The method of claim 4, wherein the transactional information includes information on payment methods.

6. The method of claim 4, wherein the transactional information includes shipping information.

7. The method of claim 4, further comprising: completing the bid process or the purchase process automatically responsive to determining that the user intends to take the action based upon receiving the second user input control.

8. The method of claim 1, wherein the second user input control is an extension of the first user input control.

9. The method of claim 1, wherein the user input directed to the user input control is a touch input to a location on a touch screen display.

10. The method of claim 9, wherein the second user input control is presented after the user input directed to the user input control is held for a predetermined period of time.

11. The method of claim 10, wherein the user input directed to the second user input control is a touch input to a second location on a touch screen display.

12. The method of claim 1, wherein the user input directed to the user input control is a button press input of a physical button.

13. A system for verification of a user action comprising:
a display module configured to present on a display, a user input control to take an action;
an input module configured to receive a user input directed to the user input control;
wherein the display module is further configured to present a second user input control responsive to the received user input directed to the user input control,
wherein the second user input control is only presented while the input directed to the user input control is still present, and wherein the input module is further configured to receive a second user input directed to the second user input control; and
a control module configured to determine that the user intends to take the action based upon receiving the second user input directed to the second user input control.

14. The system of claim 13, wherein the user input control is a button.

15. The system of claim 13, wherein the action is one of: bidding on an item in an online marketplace or purchasing an item in an online marketplace.

16. The system of claim 15, wherein the display module is configured to present transactional information for the bid or the purchase with the second user input control.

17. The system of claim 16, wherein the transactional information includes information on payment methods.

18. The system of claim 16, wherein the transactional information includes shipping information.

19. The system of claim 16, wherein the control module is configured to complete the bid process or the purchase process automatically responsive to determining that the user intends to take the action based upon receiving the second user input control.

20. The system of claim 13, wherein the second user input control is an extension of the first user input control.

21. The system of claim 13, wherein the user input directed to the user input control is a touch input to a location on a touch screen display.

22. The system of claim 21, wherein the display module is configured to present the second user input control after the user input directed to the user input control is held for a predetermined period of time.

23. The system of claim 22, wherein the user input directed to the second user input control is a touch input to a second location on a touch screen display.

24. The system of claim 13, wherein the user input directed to the user input control is a button press input of a physical button.

25. A machine readable medium that stores instructions which when performed by a machine, cause the machine to perform operations comprising:
presenting, on a display, a user input control to take an action;
receiving a user input directed to the user input control;
presenting a second user input control responsive to the received user input directed to the user input control, wherein the second user input control is only presented while the input directed to the user input control is still present; and
determining that the user intends to take the action based upon receiving a second user input directed to the second user input control.

26. The machine readable medium of claim 25, wherein the user input control is a button.

27. The machine readable medium of claim 25, wherein the action is one of: bidding on an item in an online marketplace or purchasing an item in an online marketplace.

28. The machine readable medium of claim 27, wherein the instructions for presenting the second user input control includes instructions, which when performed by the machine cause the machine to at least present transactional information for the bid or the purchase.

29. The machine readable medium of claim 28, wherein the transactional information includes information on payment methods.

30. The machine readable medium of claim 28, wherein the transactional information includes shipping information.

31. The machine readable medium of claim 28, wherein the instructions include instructions which when executed cause the machine to perform the operations of completing the bid process or the purchase process automatically responsive to determining that the user intends to take the action based upon receiving the second user input control.

32. The machine readable medium of claim 25, wherein the second user input control is an extension of the first user input control.

33. The machine readable medium of claim 25, wherein the user input directed to the user input control is a touch input to a location on a touch screen display.

34. The machine readable medium of claim 33, wherein the instructions cause the machine to present the second user input control after the user input directed to the user input control is held for a predetermined period of time.

35. The machine readable medium of claim 34, wherein the user input directed to the second user input control is a touch input to a second location on a touch screen display.

36. The machine readable medium of claim 25, wherein the user input directed to the user input control is a button press input of a physical button.
